(19) United States
(12) Patent Application Publication
(10) Pub. No.: US 2020/0247685 A1
(43) Pub. Date: Aug. 6, 2020

(54) Tungsten Hexafluoride Production Method

(71) Applicant: Central Glass Company, Limited, Ube-shi, Yamaguchi (JP)

(72) Inventors: Masakiyo NAGATOMO, Higashiomi-shi, Shiga (JP); Akifumi YAO, Ube-shi, Yamaguchi (JP); Shuhei UESHIMA, Ota-ku, Tokyo (JP); Akiou KIKUCHI, Ube-shi, Yamaguchi (JP)

(21) Appl. No.: 16/756,058

(22) PCT Filed: Oct. 4, 2018
(86) PCT No.: PCT/JP2018/037134

§ 371 Date: Apr. 14, 2020

(30) Foreign Application Priority Data
Dec. 19, 2017 (JP) 2017-242821

(51) Int. Cl. C01G 41/04; B01J 8/02

(52) U.S. Cl. CPC C01G 41/04; B01J 2208/00212; B01J 8/0285; B01J 8/0278

(57) ABSTRACT

According to the present invention, there is provided a method of producing tungsten hexafluoride by reacting tungsten with a fluorine-containing gas at a temperature of 800° C. or higher. The method according to the present invention is advantageous in that the amount of production of the tungsten hexafluoride per unit capacity of the reaction vessel is increased as compared to conventional techniques of producing tungsten hexafluoride from a fluorine-containing gas and metal tungsten while controlling the reaction temperature to 400° C. or lower. It is preferable that the reaction vessel is equipped with a coolant jacket for maintaining an inner wall temperature of the reaction vessel at 400° C. or lower.

### FIELD OF THE INVENTION

The present invention relates to a method of producing tungsten fluoride by reaction of tungsten with a fluorine-containing gas.

### BACKGROUND ART

Tungsten hexafluoride is useful as a precursor for chemical vapor deposition of tungsten and tungsten compounds. As a production method of tungsten hexafluoride, there is widely used is a technique in which tungsten is reacted with fluorine or a technique in which tungsten is reacted with nitrogen trifluoride. The standard heat ΔH_{298K, 1 atm} of formation of tungsten hexafluoride as represented by Reaction Formula (1) is −1722 kJ/WF₆ mol; whereas the standard heat ΔH_{298K, 1 atm} of formation of tungsten hexafluoride as represented by Reaction Formula (2) is −1458 kJ/WF₆ mol.

W(s)+F₂(g)→WF₆(g) Reaction Formula (1)

W(s)+2NF₃(g)→WF₆(g)+N₂(g) Reaction Formula (2)

The reactions of Reaction Formulas (1) and (2) each proceed at a very fast reaction rate with a large heat of formation and thus cause a rapid increase of temperature. Various considerations have been made on these reactions so as to control the reaction temperature in the reaction vessel to 400° C. or lower and prevent the reaction vessel from becoming corroded by the high-temperature fluorine-containing gas.

In one production process of tungsten hexafluoride, tungsten is filled in the form of a fixed bed in the reaction vessel. As a production example using such a fixed-bed reaction vessel, Patent Documents 1 and 2 disclose a method of producing tungsten hexafluoride by reacting tungsten, which has been molded with the addition of sodium fluoride as a molding aid in order to prevent a fine powder of raw metal material from being mixed in the product, with a fluorine-containing gas at a reaction temperature of 380 to 400° C. Further, Patent Documents 3, 4 and 5 disclose a method of producing tungsten hexafluoride by direction reaction of tungsten with a fluorine-containing gas at a reaction temperature of 200 to 400° C., a reaction temperature of 20 to 400° C. and a reaction temperature of 250 to 400° C., respectively. Patent Document 6 discloses a method of producing tungsten hexafluoride by reacting metal tungsten with fluorine gas at a temperature of 750° C. and a pressure of 1.5 atm.

There is a case where the reaction is performed using a fluidized-bed reaction vessel or a moving-bed reaction vessel to increase the area of contact between the tungsten and the fluorine-containing gas as compared with the case of using the fixed-bed reaction vessel.

As a production example using the fluidized-bed reaction vessel, Patent Documents 7 and 8 disclose a method of producing tungsten hexafluoride by forming a fluidized bed in which a powder of tungsten is fluidized with nitrogen gas, supplying a fluorine-containing gas to the fluidized bed and reacting the tungsten with the fluorine-containing gas under a condition that the temperature of the fluidized bed is 200 to 400° C.

As a production example using the moving-bed reaction vessel, Patent Document 9 discloses a method of producing tungsten hexafluoride by supplying a powder of tungsten from the upper side, supplying a fluorine-containing gas from the lower side, and then, reacting the tungsten with the fluorine-containing gas while maintaining the external temperature at 40 to 800° C.

### PRIOR ART DOCUMENTS

### Patent Documents

Patent Document 1: Japanese Laid-Open Patent Publication No. H1-234301

Patent Document 2: Japanese Laid-Open Patent Publication No. H1-234303

Patent Document 3: Japanese Laid-Open Patent Publication No. 2000-119024

Patent Document 4: Chinese Patent Application Publication No. 101070189

Patent Document 5: Chinese Patent Application Publication No. 102951684

Patent Document 6: Korean Patent Application Publication No. 10-2007-0051400

Patent Document 7: Chinese Patent Application Publication No. 101428858

Patent Document 8: Chinese Patent Application Publication No. 101723465

Patent Document 9: Chinese Patent Application Publication No. 102786092

### SUMMARY OF THE INVENTION

### Problems to be Solved by the Invention

In the fixed-bed reaction system, however, the reaction occurs locally even when the raw material is diluted with an inert solid or inert gas. There is thus a limit to the flow rate of the fluorine-containing gas as the raw material in the case where the reaction temperature is controlled to 400° C. or lower in the fixed-bed reaction system. Even in the fluidized- or moving-bed reaction system in which the tungsten physically moves, there is a limit to the flow rate of the fluorine-containing gas as the raw material in the case where the reaction temperature is controlled to 400° C. or lower. Consequently, the conventional techniques have the problem that the amount of production of the tungsten hexafluoride is small due to the difficulty in production at a reaction temperature exceeding 400° C.

Under the above circumstances, it is an object of the present invention to provide a production method of tungsten hexafluoride, by which the amount of production of the tungsten hexafluoride per reaction vessel is increased as compared to the conventional techniques of producing tungsten hexafluoride from a fluorine-containing gas and metal tungsten while controlling the reaction temperature to 400° C. or lower.

### Means for Solving the Problems

The present inventors have found as a result of extensive researches that the amount of production of tungsten hexafluoride per reaction vessel is increased by reacting tungsten with a fluorine-containing gas at a reaction temperature of 800° C. or higher. The present invention is based on this finding.

Accordingly, one aspect of the present invention is to provide a production method of tungsten hexafluoride, comprising forming tungsten hexafluoride by bringing tungsten into contact with a fluorine-containing gas at a reaction temperature of 800° C. or higher.

### Effects of the Invention

The production method of tungsten hexafluoride according to the present invention enables efficient reaction between the metal tungsten and the fluorine-containing gas in the reaction vessel, whereby the amount of production of the tungsten hexafluoride per reaction vessel is increased.

### BRIEF DESCRIPTION OF THE DRAWINGS

FIG. 1 is a schematic view of a reaction device according to one embodiment of the present invention.

### DETAILED DESCRIPTION OF THE EMBODIMENTS

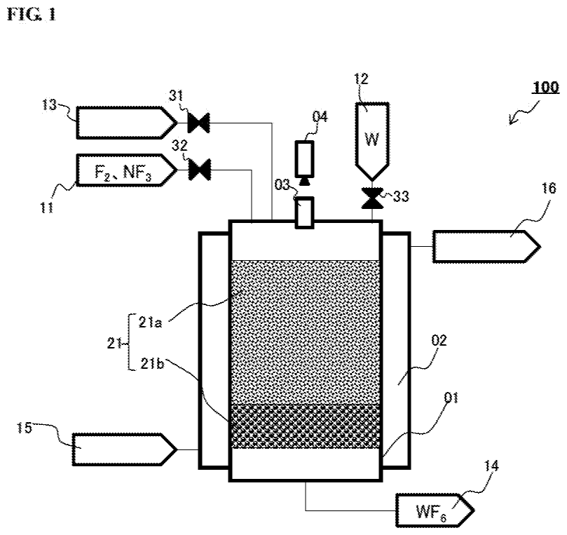

A production method of tungsten hexafluoride by solid-gas reaction of metal tungsten with a fluorine-containing gas according to one embodiment of the present invention will be described in detail below with reference to FIG. 1. It should however be understood that the present invention is not limited to the following embodiment.

[Reaction System]

The solid-gas reaction for implementation of the present invention can be performed in a fixed bed system, a moving bed system, a fluidized bed system, an entrained bed system, a tumbled bed system or the like. The reaction system in which the tungsten moves, such as moving bed system, fluidized bed system, entrained bed system or tumbled bed system, can cause wear or damage of reaction device because of high hardness of the tungsten. Thus, preferred is the reaction system in which the tungsten is immobile, such as fixed bed system.

The reaction device 100 is one example of fixed-bed reactor, and has a reaction vessel 01 equipped with a coolant jacket 02 through which a coolant for heat exchange of reaction heat flows. The reaction vessel 01 is also equipped with: a non-contact thermostat 04 for measuring the temperature of a reaction region 21a of a tungsten filled layer through an optical window 03; a fluorine-containing gas supply unit 11; a tungsten supply unit 12; a diluent gas supply unit 13; and a port for discharge of outlet gas 14. The coolant jacket 02 is provided with coolant inlet and outlet ports 15 and 16. The coolant jacket 02 may have therein a baffle plate to prevent non-uniform flow of the coolant. In the reaction vessel 01, there exists the tungsten filled layer 21 in which the tungsten supplied from the tungsten supply unit is filled. The reaction vessel 01 with which the tungsten filled layer 21 is in contact has an outer surface covered by the coolant jacket 02. The tungsten in a solid state is filled in the form of a fixed bed in the reaction vessel 01.

The reaction region 21a is a region of the tungsten filled layer 21 in which the fluorine-containing gas is supplied and reacts with the tungsten. A region of the tungsten filled layer 21 in which the fluorine-containing gas has all been consumed so that the tungsten remains unreacted with the fluorine-containing gas is called an unreacted region 21b. In FIG. 1, the unreacted region 21b is located on a lower side of the reaction region 21a, i.e., on a downstream side of the gas flow. Hence, the tungsten hexafluoride formed in the reaction region 21a is cooled by the unreacted region 21b. In the present embodiment, at least a part of the reaction region 21a is controlled to 800° C. or higher.

There is no particular limitation on the material of the reaction vessel 01. The material of the reaction vessel 01 can be selected depending on the temperature experienced by the reaction vessel and the kind of the gas brought into contact with the reaction vessel. In the case where the contact gas is a mixture of the fluorine-containing gas and the tungsten hexafluoride or in the case where the experienced temperature is 200° C. or higher, it is preferable to use nickel or nickel-based alloy, both of which are highly resistant to corrosion. In the case where the experienced temperature is lower than 200° C., there can be used austenite stainless steel or aluminum-based alloy. In terms of the mixing of material-derived impurities into the tungsten hexafluoride and the corrosion resistance, strength and cost effectiveness of the material, nickel or austenite stainless steel is preferably used.

Although the optical window 03 and the non-contact thermometer 04 are not necessarily provided for implementation of the present invention, it is preferable to provide the optical window 03 and the non-contact thermometer 04 for the purpose of measuring the internal temperature of the reaction vessel. There is no particular limitation on the window material of the optical window 03. Preferred examples of the window material are calcium fluoride, barium fluoride, quartz and the like. Among others, calcium fluoride is particularly preferred. The non-contact thermometer 04 is preferably a radiation thermometer or an optical pyrometer. The radiation thermometer can be used by calibrating the emissivity with the true temperature in the case of a single-color thermometer and by calibrating the emissivity ratio with the true temperature in the case of a two-color thermometer. Any temperature measurement means, other than the optical window 03 and the non-contact thermometer 04, may be used. As the optical window 03 and the non-contact thermometer 04 are disposed on an upper part of the reaction vessel 01 in FIG. 1, the temperature of the reaction region 21a of the tungsten filled layer 21 can be measured from the fluorine-containing gas supply side.

It is preferable that the fluorine-containing gas supply unit 11 and the diluent gas supply unit 13 are each equipped with a feeder capable of continuously feeding the gas. For example, the gas supply unit is preferably equipped with a mass flow controller. The tungsten supply unit 12 can be of the type using a continuous feeding system or intermittent feeding system. Since the fluorine-containing gas shows a high reactivity and has a risk of reacting with the tungsten in the tungsten supply unit 12, the intermittent feeding system is more preferred. As the feeding system, there can be used a rotary valve with a hopper, a screw feeder, a table feeder or the like. Alternatively, the tungsten may be supplied directly from a hopper into the reaction vessel 01 without through the medium of a feeder.

In the present invention, the influence of radiant heat from the reaction region (tungsten) is large because the reaction temperature is 800° C. or higher. It is thus preferable that the inside of the reaction vessel is as low in emissivity as possible, that is, as high in reflectivity as possible in order to prevent the inner surface of the reaction vessel from reaching an excessively high temperature. For example, the emissivity is preferably 0.5 or lower. For decrease of the emissivity, it is preferable that: the surface roughness of the inner wall of the reaction vessel and the top is as small as possible; and there is no adhesion of foreign matter to the inner wall of the reaction vessel and the top.

[Raw Material]

Preferred examples of the fluorine-containing gas are fluorine gas and nitrogen trifluoride gas. In the case of using the nitrogen trifluoride gas, nitrogen gas is also formed as a product so that the partial pressure of the tungsten hexafluoride is lowered. In such a case, it is necessary to set the cooling temperature of a collector for collection of the tungsten hexafluoride. It is thus preferable to use the fluorine gas without dilution. The tungsten hexafluoride can be formed using an interhalogen compound such as chlorine trifluoride or iodine heptafluoride. However, the use of the interhalogen compound is not favorable because of the mixing of a halogen other than fluorine into the tungsten hexafluoride. There is no particular limitation on the purity of the fluorine-containing gas for implementation of the present invention. For example, the purity of the fluorine-containing gas is preferably 95 vol % or higher, more preferably 99 vol % or higher, in order to reduce the load of recovery and purification of the formed tungsten hexafluoride.

For implementation of the present invention, it is preferable that a diluent gas is not added in order to reduce the load of recovery and purification of the formed tungsten hexafluoride. In the conventional techniques, it is necessary to use the diluent gas in order to prevent the reaction temperature from becoming excessively high. In the present invention, by contrast, the fluorine-containing gas is usable in undiluted form because the reaction temperature can be raised to a high temperature. On the other hand, the diluent gas may be added as appropriate in order to protect a plurality of pipes and measurement instruments disposed on the upper part of the reaction vessel from convective heat transfer or radiant heat, perform gas replacement on the reaction device 100, lower the partial pressure of the tungsten hexafluoride, or the like. The diluent gas is preferably a gas that does not react with the fluorine-containing gas, the tungsten hexafluoride and the reaction vessel. For example, there can be used tungsten hexafluoride, nitrogen gas, helium gas or argon gas as the diluent gas.

There is no particular limitation on the purity of the tungsten for implementation of the present invention. For example, the purity of the tungsten is preferably 99 mass % or higher in order to obtain the tungsten hexafluoride with a purity of 99.999 vol % or higher. There is also no particular limitation on the form of the tungsten for implementation of the present invention. For example, the tungsten is usable in the form of a powder, a compact body of a powder, a block, a granule, a rod, a plane or the like solely or in combination thereof.

[Coolant and its Flow Rate]

In the present embodiment, the reaction vessel 01 is cooled with the coolant such that the inner wall temperature of the reaction vessel is set to 400° C. or lower even though the reaction temperature of the reaction region 21a is 800° C. or higher. This prevents damage caused to the reaction vessel by the fluorine-containing gas and the tungsten hexafluoride gas. In the case where the reaction vessel is simply placed in the air without using the coolant jacket 02 and is cooled with the air, the inner wall temperature of the reaction vessel exceeds 400° C. so that damage can be caused to the reaction vessel. The inner wall temperature of the reaction vessel depends on the temperature of the coolant. In the case of using water as the coolant, the inner wall temperature of the reaction vessel is generally set to 5° C. or higher.

There is no particular limitation on the kind of the coolant flowing in from the coolant inlet port 15, flowing through the coolant jacket 02 and then flowing out from the coolant outlet port 16 and the flow rate of the coolant. The kind and flow rate of the coolant can be set such that the film coefficient of heat transfer between the coolant and the reaction vessel falls within the range of 500 W/m²/K to 5000 W/m²/K. When the film coefficient of heat transfer is lower than 500 W/m²/K, the cooling rate is low so that the inner wall temperature of the reaction vessel may become 400° C. or higher. Various methods of calculation of the film coefficient of heat transfer have been proposed for selection of the coolant and determination of the flow rate of the coolant. In the case of a flat plate transfer mechanism, for example, the following formulas are known.

Nu=0.664Re^{1/2}Pr^{1/3} (Formula 3)

Nu=0.037Re^{4/5}Pr^{1/3} (Formula 4)

Herein, Nu is the Nusselt number; Re is the Reynolds number; and Pr is the Prandtl number. The definition of these numbers are as follows.

Nu=hL/λ (Formula 5)

Re=Duρ/μ (Formula 6)

Pr=Cpμ/λ (Formula 7)

In the above formulas, λ is the thermal conductivity of the fluid; h is the film coefficient of heat transfer; L is the characteristic length; D is the hydraulic diameter of the pipe through which the coolant flows; u is the flow rate of the coolant; μ is the viscosity of the coolant; and Cp is the heat capacity of the coolant.

More specifically, water, brine, silicone oil, steam, air or the like can be selected as the coolant. Among others, water is preferred in terms of the price and physical properties. In the case of using water as the coolant, the temperature of the water as the coolant is preferably in the range of 5° C. to 95° C., more preferably 10° C. to 80° C. This is because the water may be frozen at a temperature lower than 5° C. and vaporized at a temperature higher than 95° C. and thus may not function as the coolant at temperatures lower than 5° C. and higher than 95° C.

In the case of using water as the coolant, the state of flow of the water as the coolant in the coolant jacket 02 is controlled such that the Reynolds number (Re) is preferably in the range of 500 to 50000, more preferably 2000 to 20000. When the Reynolds number is lower than 500, the film coefficient of heat transfer between the coolant and the metallic jacket wall is not sufficiently high so that the reaction heat may not be removed and thereby cause damage to the reaction vessel. When the Reynolds number exceeds 50000, the flow rate of the coolant needs to be set high relative to an arbitrary hydraulic diameter so that the pump and auxiliary equipment thereof becomes unfavorably costly.

Re=De×u×ρ/μ (Formula 8)

In the above formula, De is the hydraulic diameter (m) of the jacket; u is the flow rate (m/s); ρ is the density (kg/m3) of the coolant; and μ is the viscosity (Pa·s) of the coolant.

[Pressure and Temperature of Reaction Vessel]

The pressure exerted on the reaction vessel 01, pipes and measurement instruments during the reaction is preferably 10 kPa to 300 kPa, more preferably 30 kPa to 200 kPa, in terms of the absolute pressure. When the pressure is lower than 10 kPa, the load of pressure-maintaining auxiliary equipment such as pressure reducing pump becomes large. When the pressure is higher than 300 kPa, the reaction device needs to have a pressure-resistant, corrosion-resistant structure.

[Reaction Temperature]

In the present invention, the reaction temperature of the tungsten and the fluorine-containing gas is 800° C. or higher. Since the exothermic reaction proceeds by contact of the fluorine-containing gas with the tungsten, the reaction temperature can be defined in the present invention as the temperature of the region in which the tungsten and the fluorine-containing gas come into contact and react with each other as measured from the fluorine-containing gas supply side. In the present invention, the reaction temperature does not refers to the reaction temperature in a local area of micrometer size, but refers to the reaction temperature in a substantially circular area of at least 1 mm or more diameter, preferably in a substantially area of 10 mm or more diameter.

In the case of using the tungsten filled layer 21 in which the solid tungsten is filled in the reaction vessel 01, the reaction region 21 is heated by the reaction heat whereby at least a part of the reaction region 21a reaches 800° C. or higher. As the fluorine-containing gas is supplied from the upper side in FIG. 1, the reaction temperature in the reaction vessel 01 means the temperature of an uppermost or outermost part of the reaction region 21a during the reaction of the tungsten with the fluorine-containing gas as measured from the fluorine-containing gas supply side.

However, the whole of the reaction region 21a of the tungsten filled layer 21 is not necessarily at 800° C. or higher. For example, the embodiment of FIG. 1 may be implemented such that the uppermost part of the reaction region 21a reaches 800° C. or higher while a part of the reaction region 21 near the unreacted region 21b remains at 800° C. or lower.

In the present invention, the reaction temperature of the tungsten and the fluorine-containing gas is preferably 800° C. to 3400° C. When the reaction temperature is lower than 800° C., the heat exchanger or reaction vessel may be increased in size to maintain the temperature as in the conventional techniques. This unfavorably leads to a decrease in the amount of production of the tungsten hexafluoride per unit capacity of the reaction vessel.

In order to increase the amount of production of the tungsten hexafluoride, the reaction temperature is more preferably 900° C. or higher, still more preferably 1000° C. or higher, yet more preferably 1200° C., still yet more preferably 1400° C. or higher. When the reaction temperature exceeds 3400° C., on the other hand, the tungsten may unfavorably melt. This raises a possibility that the normal solid-gas reaction cannot be performed. In view of the fact that tungsten undergoes thermal decomposition at a temperature of about 1200° C. to 2500° C., the reaction temperature is more preferably 2500° C. or lower, still more preferably 2000° C. or lower, particularly preferably 1800° C. or lower.

The temperature of a gas-outlet-side outermost part of the unreacted region 21b (i.e. a lowermost part of the unreacted region 21b in FIG. 1) of the tungsten filled layer 21, through which the tungsten hexafluoride formed by the reaction flows, is preferably 5° C. to 400° C. Since the tungsten hexafluoride formed in the reaction region 21a is cooled by the unreacted region 21b, the temperature of the outlet gas 14 becomes 5° C. to 400° C. in the same manner as the temperature of the lowermost part of the unreacted region 21b. When the temperature of the outlet gas 14 is lower than 5° C., the formed tungsten hexafluoride may be condensed or solidified. When the temperature of the outlet gas 14 exceeds 400° C., damage may be caused to the pipes through which the coolant does not flow and to the measurement instruments. In particular, it is preferable to discontinue production of the tungsten hexafluoride in the case where the temperature of the outlet gas 14 exceeds 400° C. as the amount of tungsten filled becomes decreased with the progress of production of the tungsten hexafluoride.

The inner wall temperature of the reaction vessel 01 in contact with the tungsten filled layer 21 depends on the kind and flow state of the coolant. The inner wall temperature of the reaction vessel 01 is preferably 400° C. or lower. In the case of using water as the coolant under conditions that: the temperature of the coolant is 10° C. to 80° C.; and the Reynolds number in the jacket is 2000 or higher, the inner wall temperature is maintained at e.g. 150° C. or lower without reaching a temperature that causes damage to the reaction vessel.

The production method of tungsten hexafluoride according to the present invention has the advantage that the amount of production of the tungsten hexafluoride per reaction vessel is increased. More specifically, the production method of tungsten hexafluoride according to the present invention enables efficient contact between the fluorine-containing gas and the tungsten filled in the reaction vessel by controlling the reaction temperature to 800° C. or higher so as to make effective use of the tungsten as the raw material and thereby increase the amount of production of the tungsten hexafluoride per reaction vessel as compared to the technique of producing tungsten hexafluoride by controlling the reaction temperature to 400° C. or lower.

The production method of tungsten hexafluoride according to the present invention also has the advantage that it is easy to control the amount of supply of the fluorine-containing gas. A detailed explanation of the advantages will be given below. The reaction of the tungsten and the fluorine-containing gas proceeds with a large reaction heat. The reaction temperature thus easily exceeds 400° C. when the supply amount of the fluorine-containing gas is large. It is therefore necessary to strictly control the amount of the fluorine-containing gas supplied or perform cooling with the diluent gas in order to control the reaction temperature to 400° C. In the present invention, the reaction temperature of the tungsten and the fluorine-containing gas is achieved by heating under the action of the reaction heat between the tungsten and the fluorine-containing gas. The amount of the reaction heat between the tungsten and the fluorine-containing gas increases with increase in the supply amount of the fluorine-containing gas. On the other hand, the thermal decomposition temperature of the tungsten hexafluoride is lower than or equal to the melting point of the tungsten. The reaction temperature of the tungsten and the fluorine-containing gas does not thus easily become higher than or equal to the thermal decomposition temperature of the tungsten hexafluoride. In the production method of tungsten hexafluoride according to the present invention, the following equilibrium thermal decomposition occurs when the supply amount of the fluorine-containing gas exceeds a certain level and the reaction temperature reaches the vicinity of the thermal decomposition temperature of the tungsten hexafluoride by the action of the reaction heat. As the reaction heat between the tungsten and the fluorine-containing gas is used for the thermal decomposition of the tungsten hexafluoride, the increase of the reaction temperature is suppressed. The reaction temperature of the tungsten and the fluorine-containing gas is hence limited to about the thermal decomposition temperature of the tungsten hexafluoride. When the supply amount of the fluorine-containing gas exceeds the certain level, the reaction temperature becomes 800° C. to 3400° C., particularly 1200° C. to 2000° C., even without strict control of the supply amount of the fluorine-containing gas. Further, the fluorine gas formed by the thermal decomposition reaction can be reacted with the tungsten on a lower side of the outermost part of the tungsten filled layer 21. As a consequence, the amount of production of the tungsten hexafluoride per reaction vessel is increased.

WF₆↔W+3F₂ (Formula 9)

### EXAMPLES

The production method of tungsten hexafluoride according to the present invention will be described in more detail below by way of the following specific examples. It should however be understood that the production method of tungsten hexafluoride according to the present invention is not limited to the following specific examples.

### Example 1

Provided was a reaction device of the type shown in FIG. 2 and having a reaction vessel 01 formed of nickel with an inner diameter of 28.4 mm, an outer diameter of 34 mm and a length of 1000 mm and a coolant jacket 02 formed of stainless steel with an inner diameter of 54.9 mm (a hydraulic diameter of 20.9 mm), an outer diameter of 60.5 mm and a length of 800 mm. An optical window 03 and a two-color radiation thermometer as a non-contact thermostat 04 were disposed on an upper part of the reaction vessel. In the reaction vessel, a tungsten powder of 10 μm average particle size and a tungsten block of about 20 mm square were filled in a total amount of 1.4 kg (a filling length of 400 mm). By the non-contact thermostat 04, the temperature of the center of the uppermost part of the tungsten filled layer 21, i.e., the temperature of the center of the uppermost part of the reaction region 21a was measured with a spot diameter of 10 mm. Herein, the tungsten block had carved therein a label confirmation of a trace of reaction. The gas phase of the reaction vessel was subjected to vacuum and replaced with nitrogen gas. While flowing water of 25° C. through the coolant jacket at a flow rate of 2 L/min (i.e. under conditions that: the Re number was 2020; and the film coefficient of heat transfer between the coolant and the reaction vessel was 1370 W/m²/K), fluorine gas was introduced into the reaction vessel from the upper side at a flow rate of 5 SLM (volumetric flow rate in units of L/min at 0° C. and 1 atm). The reaction was performed with pressure control such that the pressure of the outlet gas downstream of the reaction vessel was 100 kPa (in terms of absolute pressure). During the reaction, light emission due to the reaction heat was observed through the optical window; and the radiation thermometer read 1630° C. A part of the outlet gas downstream of the reaction vessel was sampled. The partial pressure of the formed tungsten hexafluoride in the sampled gas was measured by an infrared spectrometer. Based on the measurement result, the conversion rate of the fluorine-containing gas was determined to be 99% or higher. The reaction was stopped, followed by performing gas replacement on the reaction vessel with nitrogen gas and vacuum degassing. After that, the filled tungsten was taken out of the reaction vessel. From the weight decrease of the tungsten block with the label, the reaction depth of the tungsten was determined. As a result, it was confirmed that the tungsten had been consumed to a depth of 160 mm from the uppermost part of the filled layer.

### Example 2

The reaction was carried out under the same conditions as those in Example 1, except that the flow rate of the fluorine gas was set to 3.5 SLM. During the reaction, light emission due to reaction heat was observed through the optical window; and the radiation thermometer read 1520° C. As a result of analyzing the outlet gas downstream of the reaction vessel by the infrared spectrometer, the conversion rate of the fluorine-containing gas was determined to be 99% or higher. From the weight decrease of the tungsten block, the consumption depth of the tungsten was determined to be 110 mm.

### Example 3

The reaction was carried out under the same conditions as those in Example 1, except that the flow rate of the fluorine gas was set to 0.5 SLM. During the reaction, light emission due to the reaction heat was observed through the optical window; and the radiation thermometer read 950° C. As a result of analyzing the outlet gas downstream of the reaction vessel by the infrared spectrometer, the conversion rate of the fluorine-containing gas was determined to be 99% or higher. From the weight decrease of the tungsten block, the consumption depth of the tungsten was determined to be 10 mm.

### Example 4

As the fluorine-containing gas, nitrogen trifluoride gas was used. The reaction was carried out under the same conditions as those in Example 1, except that the flow rate of the nitrogen trifluoride gas was set to 5 SLM. During the reaction, light emission due to the reaction heat was observed through the optical window; and the radiation thermometer read 1580° C. As a result of analyzing the outlet gas downstream of the reaction vessel by the infrared spectrometer, the conversion rate of the fluorine-containing gas was determined to be 99% or higher. From the weight decrease of the tungsten block, the consumption depth of the tungsten was determined to be 140 mm.

### Example 5

The reaction was carried out under the same conditions as those in Example 1, except that the flow rate of the cooling water was set to 10 L/min (that is, the Re number was 10100; and the film coefficient of heat transfer between the cooling water and the reaction vessel was 3020 W/m²/K). During the reaction, eight emission due to the reaction heat was observed through the optical window; and the radiation thermometer read 1620° C. As a result of analyzing the outlet gas downstream of the reaction vessel by the infrared spectrometer, the conversion rate of the fluorine-containing gas was determined to be 99% or higher. From the weight decrease of the tungsten block, the consumption depth of the tungsten was determined to be 150 mm.

### Example 6

The reaction was carried out under the same conditions as those in Example 1, except that the flow rate of the cooling water was set to 1 L/min (that is, the Re number was 1010; and the film coefficient of heat transfer between the cooling water and the reaction vessel was 970 W/m²/K). During the reaction, eight emission due to the reaction heat was observed through the optical window; and the radiation thermometer read 1640° C. As a result of analyzing the outlet gas downstream of the reaction vessel by the infrared spectrometer, the conversion rate of the fluorine-containing gas was determined to be 99% or higher. From the weight decrease of the tungsten block, the consumption depth of the tungsten was determined to be 170 mm.

### Comparative Example 1

The reaction was carried out under the same conditions as those in Example 1, except that: the flow rate of the fluorine gas was set to 0.2 SLM; and nitrogen gas as a diluent gas was introduced at a flow rate of 4.8 SLM. During the reaction, light emission due to the reaction heat was not observed through the optical window; and the radiation thermometer read 460° C. As a result of analyzing the outlet gas downstream of the reaction vessel by the infrared spectrometer, the conversion rate of the fluorine-containing gas was determined to be 99% or higher. Although the total supply amount of the fluorine-containing gas was the same as that in Example 1, the consumption depth of the tungsten as determined from the weight decrease of the tungsten block was less than 10 mm. The tungsten was almost not consumed.

### Comparative Example 2

The reaction was carried out under the same conditions as those in Example 4, except that: the flow rate of the nitrogen trifluoride gas was set to 0.2 SLM; and nitrogen as a diluent gas was introduced at a flow rate of 4.8 SLM. During the reaction, light emission due to the reaction heat was not observed; and the radiation thermometer read 420° C. As a result of analyzing the outlet gas downstream of the reaction vessel by the infrared spectrometer, the conversion rate of the fluorine-containing gas was determined to be 99% or higher. Although the total supply amount of the fluorine-containing gas was the same as that in Example 4, the consumption depth of the tungsten as determined from the weight decrease of the tungsten block was less than 10 mm. The tungsten was almost not consumed.

The production conditions and results of the respective examples are shown in TABLE 1.

TABLE 1

| | Conditions | | | | | | | Results | |
|---|---|---|---|---|---|---|---|---|---|
| | Kind of | Flow rate | | Flow | | Film | | Conversion | |
| | fluorine- | of fluorine- | Flow | rate of | | coefficient | | rate | Consump- |
| Example/ | contain- | containing | rate | cooling | Reynolds | of | Temper- | of fluorine- | tion |
| Comparative | ing | gas | of N₂ | water | number | heat transfer | ature | containing gas | depth of |
| Example | gas | SLM | SLM | L/min | — | W/m²/K | ° C. | % | W mm |
| Example 1 | F₂ | 5 | 0 | 2 | 2020 | 1370 | 1630 | ≥99 | 160 |
| Example 2 | F₂ | 3.5 | 0 | 2 | 2020 | 1370 | 1520 | ≥99 | 110 |
| Example 3 | F₂ | 0.5 | 0 | 2 | 2020 | 1370 | 950 | ≥99 | 10 |
| Example 4 | NF₃ | 5 | 0 | 2 | 2020 | 1370 | 1580 | ≥99 | 140 |
| Example 5 | F₂ | 5 | 0 | 10 | 10100 | 3020 | 1620 | ≥99 | 150 |
| Example 6 | F₂ | 5 | 0 | 1 | 1010 | 970 | 1640 | ≥99 | 170 |
| Comparative | F₂ | 0.2 | 4.8 | 2 | 2020 | 1370 | 460 | ≥99 | <10 |
| Example 1 | | | | | | | | | |
| Comparative | NF₃ | 0.2 | 4.8 | 2 | 2020 | 1370 | 420 | ≥99 | <10 |
| Example 2 | | | | | | | | | |

In Examples 1 to 6 according to the present invention in which the reaction temperature was 800° C. or higher, the fluorine-containing gas was reacted with the tungsten inside the tungsten filled layer. In Comparative Examples 1 and 2 according to the conventional techniques in which the upper limit of the reaction temperature was set to about 400° C., there was a limit to the flow rate of the fluorine-containing gas as compared to Examples 1 and 4 even through the linear velocity and supply amount were the same as in those examples. In these comparative examples, the consumption depth of the tungsten was small, and the amount of production of WF₆ was small.

In comparison of Examples 3 with Example 2, the reaction temperature increased with increase in the flow rate of the fluorine-containing gas. In comparison of Example 2 with Example 1, the reaction temperature did almost not increase even though the flow rate of the fluorine-containing gas was increased. It is thus considered that, in Example 1, the thermal decomposition equilibrium of WF₆ was achieved whereby the increase of the reaction heat was suppressed. Furthermore, the consumption depth of the tungsten was large, and the amount of production of WF₆ was large, in Examples 1 and 2 in which the reaction temperature was at a high level of 1500° C. or higher as compared to Example 3 in which the reaction temperature was 950° C.

### DESCRIPTION OF REFERENCE NUMERALS

100: Reaction device
01: Reaction vessel
02: Coolant jacket
03: Optical window
04: Non-contact thermometer
11: Fluorine-containing gas supply unit
12: Tungsten supply unit
13: Diluent gas supply unit
14: Outlet gas
15: Coolant inlet port
16: Coolant outlet port
21: Tungsten filled layer
31, 32, 33: Valve

1.-10. (canceled)

11. A production method of tungsten hexafluoride, comprising: forming tungsten hexafluoride by reaction of tungsten with a fluorine-containing gas in a reaction vessel,
wherein the reaction vessel is equipped with a coolant jacket, and
wherein the reaction is performed in the reaction vessel at a reaction temperature of 800° C. or higher while an inner wall temperature of the reaction vessel is maintained at a temperature of 400° C. or lower by the coolant jacket.

12. The production method of tungsten hexafluoride according to claim 11, wherein the fluorine-containing gas is either one or both of fluorine gas and nitrogen trifluoride gas.

13. The production method of tungsten hexafluoride according to claim 11, wherein the fluorine-containing gas is undiluted fluorine gas.

14. The production method of tungsten hexafluoride according to claim 11, wherein the tungsten is filled in the form of a fixed bed in the reaction vessel.

15. The production method of tungsten hexafluoride according to claim 11, wherein the reaction temperature is in a range of 1200° C. to 2000° C.

16. The production method of tungsten hexafluoride according to claim 11,
wherein a coolant flowing through the coolant jacket is water, and
wherein a film coefficient of heat transfer between the coolant and the reaction vessel is 500 W/m²/K or higher.

17. The production method of tungsten hexafluoride according to claim 11,
wherein the fluorine-containing gas is fluorine gas, and
wherein the tungsten is filled in the form of a fixed bed in the reaction vessel.

18. A production device of tungsten hexafluoride, comprising:
a reaction vessel having therein a tungsten filled layer;
a fluorine-containing gas supply unit that supplies a fluorine-containing gas into the reaction vessel; and
a coolant jacket that cools the reaction vessel so as to set an inner wall temperature of the reaction vessel to a temperature of 400° C. or lower,
wherein the tungsten filled layer includes, in a part thereof, a reaction region in which the tungsten hexafluoride is formed by contact of tungsten with the fluorine-containing gas at 800° C. or higher.

19. The production device of tungsten hexafluoride according to claim 18, wherein the tungsten filled layer includes, in a part thereof, an unreacted region in which the tungsten hexafluoride formed in the reaction region is cooled to 5° C. to 400° C. by unreacted tungsten.

20. A production method of tungsten hexafluoride, comprising: forming tungsten hexafluoride by reaction of tungsten with a fluorine-containing gas,
wherein the reaction is performed at a reaction temperature of 1200° C. to 2000° C.

21. The production method of tungsten hexafluoride according to claim 20, wherein the fluorine-containing gas is either one or both of fluorine gas and nitrogen trifluoride gas.

22. The production method of tungsten hexafluoride according to claim 20, wherein the fluorine-containing gas is undiluted fluorine gas.

23. The production method of tungsten hexafluoride according to claim 20, wherein the reaction is performed in a reaction vessel in which the tungsten is filled in the form of a fixed bed in the reaction vessel.

24. The production method of tungsten hexafluoride according to claim 20,
wherein the reaction is performed in a reaction vessel equipped with a coolant jacket,
wherein a coolant flowing through the coolant jacket is water, and
wherein a film coefficient of heat transfer between the coolant and the reaction vessel is 500 W/m²/K or higher.
